(19) United States
(12) Patent Application Publication
(10) Pub. No.: US 2012/0200298 A1
(43) Pub. Date: Aug. 9, 2012

(54) Automotive Battery SOC Estimation Based on Voltage Decay

(75) Inventors: Yilu Zhang, Northville, MI (US); Niannian Tong, Ann Arbor, MI (US); Mutasim A. Salman, Rochester Hills, MI (US); Kevin R. Bainbridge, Rochester Hills, MI (US); David W. Walters, Sterling Heights, MI (US)

(73) Assignee: GM GLOBAL TECHNOLOGY OPERATIONS LLC, Detroit, MI (US)

(21) Appl. No.: 13/023,748

(22) Filed: Feb. 9, 2011

(51) Int. Cl. G01N 27/416

(52) U.S. Cl. 324/427

(57) ABSTRACT

A method is provided for determining a state-of-charge of a battery for a vehicle. The vehicle is in a charging state when the engine is operating and a non-charging state when the engine is not operating. A first battery voltage is measured at a first predetermined time period after battery charging is discontinued in the non-charging state. A first temperature of the battery is measured that coincides with the first battery voltage. A second battery voltage is measured at a second predetermined time. The second predetermined time is greater than the first predetermined time. A second temperature of the battery is measured that coincides with the second battery voltage. An average temperature is calculated based on the first temperature measurement and the second temperature measurement. A fixed time constant is determined based on the average temperature. An open circuit voltage is estimated as a function of the first voltage measurement, the second voltage measurement, and the fixed time constant. A state-of-charge of the battery is determined based on the estimated open circuit voltage.

### BACKGROUND OF INVENTION

An embodiment relates generally to external device integration within a vehicle.

Determining a state-of-charge (SOC) for a battery can be performed utilizing various techniques utilizing coulomb counting or parameter estimations techniques. Coulomb counting involves the use of one measurement (i.e., one open circuit voltage reading) to estimate the battery state-of-charge. The accuracy of the open circuit voltage is critical to determining a state of charge. If there is measurement error, such as the current sensor not accurate integration error accumulates quickly, unless the startup SOC is frequently and accurately updated.

Parameter estimation-based algorithms utilize constant updates of open circuit voltages during vehicle operation. This requires significant excitations which are not necessarily available for conventional vehicles.

### SUMMARY OF INVENTION

An advantage of an embodiment is the estimation of the state of charge of a vehicle battery prior to an open circuit voltage of the battery not at equilibrium. The open circuit voltage of the battery is estimated utilizing voltage measurements that are taken prior to the open circuit voltage reaching an equilibrium state, and while the vehicle is in a non-charging state. The voltage measurements are utilized by an open circuit voltage technique utilizing a voltage decay model for estimating the open circuit voltage at equilibrium. The open circuit voltage is mapped to a state of charge value for determining the state of charge of the vehicle battery.

An embodiment contemplates a method of determining a state-of-charge of a battery for a vehicle. The vehicle is in a charging state when the engine is operating and a non-charging state when the engine is not operating. A first battery voltage is measured at a first predetermined time after battery charging is discontinued in the non-charging state. A first temperature of the battery is measured coinciding with the first battery voltage. A second battery voltage is measured at a second predetermined time after the first predetermined time with the vehicle in the non-charging state. The second predetermined time is greater than the first predetermined time. A second temperature of the battery is measured coinciding with the second battery voltage. An average temperature is calculated based on the first temperature measurement and the second temperature measurement. A fixed time constant is determined based on the average temperature. An open circuit voltage is estimated as a function of the first voltage measurement, the second voltage measurement, and the fixed time constant. A state-of-charge of the battery is determined based on the estimated open circuit voltage.

An embodiment contemplates a system for determining a state-of-charge of a battery for a vehicle. The vehicle is in a charging state when the engine is operating and a non-charging state when the engine is not operating. The system includes a battery, and a voltmeter for measuring a first battery voltage at a first predetermined time after battery charging is discontinued in the non-charging state. The voltmeter also measures a second battery voltage at a second predetermined time after battery charging is discontinued. The second predetermined time is greater than the first predetermined time. A temperature sensor measures a first temperature of the battery coinciding with the first battery voltage, and the temperature sensor measures a second temperature of the battery coinciding with the second battery voltage. A control module determines a fixed time constant as a function of the first and second temperature measurements. The control module estimates an open circuit voltage at equilibrium as a function of the first battery voltage, the second battery voltage, and the fixed time constant. The control module determines a state-of-charge of the battery based on the estimated open circuit voltage.

### BRIEF DESCRIPTION OF DRAWINGS

FIG. 1 is a diagrammatic representation of an embodiment of a vehicle having a vehicle battery state of art estimation system according to an embodiment.

FIG. 2 is a flowchart of a method for estimating the state of charge of the vehicle battery according to the embodiment.

### DETAILED DESCRIPTION

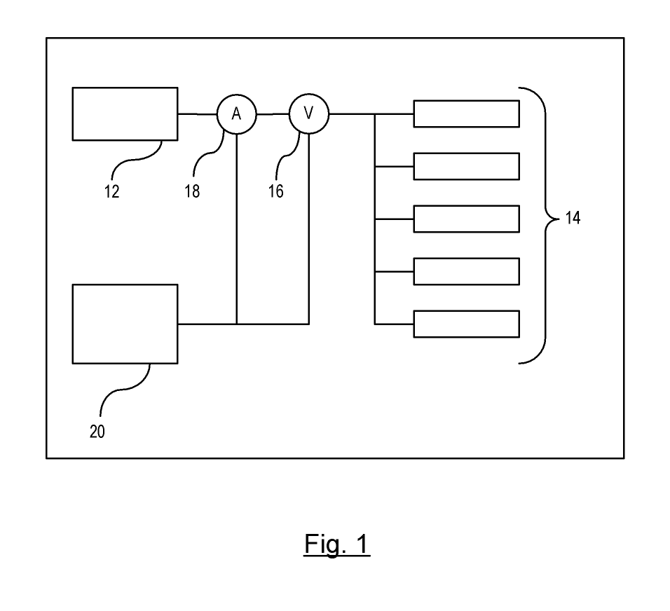

FIG. 1 illustrates a block diagram of an embodiment of a vehicle 10 incorporating a state-of-charge (SOC) estimation system. The vehicle 10 includes a battery 12 for starting the vehicle. The battery 12 is a lead-acid battery. The battery is made up of cells that contain electrodes (cathode and anode) of lead (Pb) and lead oxide (PbO₂) in an electrolyte of sulfuric acid. A chemical reaction takes place to store energy within the battery. The concept is to convert lead sulphate that forms the plates of a discharged battery into lead and lead dioxide which forms the plates of a charged battery.

The vehicle battery 12 is electrically coupled to a plurality of devices 14 which utilize the battery as a power source. The vehicle 10 may further include a current sensor 16, a voltage meter 18, and a control module 20.

The plurality of devices 14 include, but are not limited to, power outlets adapted to an external device, accessories, components, subsystems, and systems of a vehicle. The current sensor 16 is used to monitor the current leaving the vehicle battery 12. The voltmeter 18 measures a voltage so that an open circuit voltage (OCV) may be determined. A control module 20, or similar module, obtains, derives, monitors, and/or processes a set of parameters associated with the vehicle battery 12. These parameters may include, without limitation, current, voltage, state-of-charge (SOC), battery capacity, battery internal resistances, battery internal reactance, battery temperature, and power output of the vehicle battery. The control module 20 includes an algorithm, or like, for executing a vehicle state-of-charge (SOC) estimation technique.

The control module 20 utilizes the OCV of the battery for determining the SOC. To accurately determine the SOC, the OCV may be accurately measured only after the OCV equilibrium is obtained, which occurs a predetermined time after battery charging has been discontinued (i.e., either by an ignition off operation or other charging device). Typically the predetermined time to obtain OCV equilibrium includes 24 hours after charging the battery is discontinued. That is, an open-circuit voltage measurement is accurate only when the battery voltage is under the equilibrium conditions. Electrical charges on the surface of the battery's plates cause false voltmeter readings. False voltmeter readings are due to surface charges on the battery plates. When a battery is charged, the surface of the plates may have a higher charge than the inner portions of the plates. After a period of time after charging has been discontinued, the surface charge on the surface of the plates will become slightly discharged as a result of the charged energy penetrating deeper into the plates. Therefore, the surface charge, if not dissipated to the inner portion of the plates, may make a weak battery appear good. As a result, to obtain an accurate OCV measurement that can be used to determine the SOC, the vehicle typically must be at rest (i.e., no battery charging) for 24 hours. The embodiment described herein provides a technique for estimating an accurate OCV measurement when the battery has been at rest for less than 24 hours.

To estimate the OCV of the battery, an OCV estimation algorithm is derived from a voltage decay model that is represented by the following equation:

V=α+b·e^{m·(t-t}^{₀}⁾ (1_)

where V is a voltage reading at a respective time t, m is a fixed time constant, and α and b are parameters.

The voltage decay model as represented in eq. (1) is refined for deriving the OCV estimation algorithm. To derive the OCV estimation algorithm, the voltage decay model in eq. (1) is first solved for parameters α and b. Since parameters α and b are unknown, a first voltage decay model equation is derived in terms of parameter α and a second voltage decay model equation is derived in terms of parameter b. As a result, parameters α and b may be solved for by isolating one variable in the voltage decay model and solving for it. Once the first variable is solved for, the other variable may be solved for by substituting the first solved for variable back into the voltage decay algorithm and solving for the second variable. The voltages and time parameters used in each formula may be any voltage that is obtained at a time instant greater than 3 hours. For example, a first measured voltage obtained the third hour when in the non-charging state may be used to solve for parameter α, whereas a second measured voltage obtained after the fourth hour when in the non-charging state may be used to solve for parameter b. By substituting each solved-for parameter α and b back into the voltage decay model of eq. (1), the following equation is derived:

$${OCV}_{( est )} = {V}_{3} - ( {V}_{3} - {V}_{4} ) \cdot \frac{{e}^{3 \times 3600 \times m} - {e}^{t \times 3600 \times m}}{{e}^{3 \times 3600 \times m} - {e}^{4 \times 3600 \times m}} \qquad ( 2 )$$

where V₃ and V₄ are voltages measured after third hour and the fourth hour when in the non-charging state, respectively, and t is the time at which the open circuit voltage reaches equilibrium. The time as illustrated in eq. (2) is converted into seconds. Preferably, the time t at which the battery reaches equilibrium is 24 hours. Alternatively, any time greater than 8 hours may be used. Moreover, the voltage measurements V₃ and V₄ should be taken at a time that is greater than at least 3 hours when in the non-charging state. The fixed time constant m is based on a battery temperature T which is represented by the following temperature ranges:

$$if T \geq 25 C , then m = {m}_{25} = - 3 \times {10}^{- 5} , \\ if T \leq 0 C , then m = {m}_{0} = - 2 \times {10}^{- 5} , \\ if 0 C < T < 25 C , then m = {m}_{0} + \frac{T}{25} ( {m}_{25} - {m}_{0} ) . \qquad ( 3 )$$

As a result, selecting t=24 hour as the time when the OCV reaches equilibrium, the OCV estimation algorithm is as follows:

$${OCV}_{( est )} = {V}_{3} - ( {V}_{3} - {V}_{4} ) \cdot \frac{{e}^{3 \times 3600 \times m} - {e}^{24 \times 3600 \times m}}{{e}^{3 \times 3600 \times m} - {e}^{4 \times 3600 \times m}} \qquad ( 4 )$$

Once the OCV is estimated, the OCV may be mapped to an SOC value using a conversion table, or similar conversion technique. If the SOC of the battery is below a predetermined level, a warning may be provided to the driver of the vehicle, or the determination may be provided to an electronic control unit of the vehicle to command the charging device, such as a generator, to charge the battery.

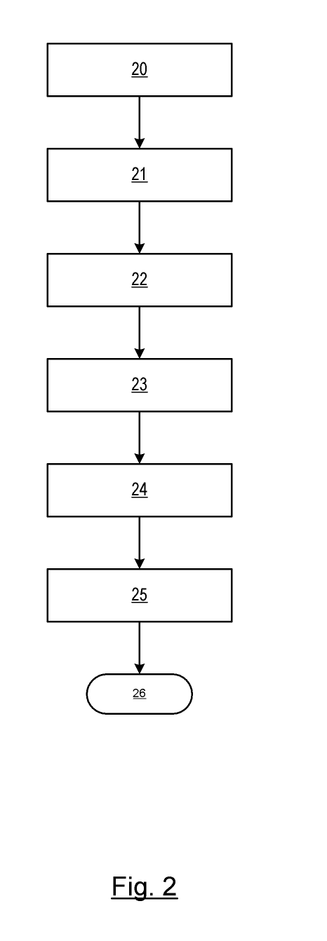

FIG. 2 is a flowchart for estimating the SOC of the vehicle. In step 20, the vehicle ignition key is turned to the off position (e.g., engine off).

In step 21, a first voltage (V₃) and a battery temperature (T₃) coinciding with the first voltage (V₃) is collected after the vehicle ignition has been turned off for 3 hours.

In step 22, the second voltage (V₄) and the battery temperature (T₄) coinciding with the second voltage (V₄) is collected after the vehicle ignition has been turned off for 4 hours.

In step 23, a battery equilibrium voltage is determined using a battery equilibrium voltage estimation as represented by the following formula:

$${OCV}_{est} = {V}_{3} - ( {V}_{3} - {V}_{4} ) \cdot \frac{{e}^{3 \times 3600 \times m} - {e}^{24 \times 3600 \times m}}{{e}^{3 \times 3600 \times m} - {e}^{4 \times 3600 \times m}} \qquad ( 5 )$$

where V₃ and V₄ is estimated based on an average of the measured temperature after the 3 hours and 4 hours. It should be understood that any voltage greater than 3 hours may be used; however, utilizing voltages at the end of the third and fourth hours provide the earliest estimation that can be accurately determined once the vehicle ignition is off. Moreover, equilibrium of the OCV may be estimated any time after 8 hours; however, 24 hours is utilized at which time typically results in surface charges dissipating within the plates of the battery. In determining the fixed time constant m, an average temperature T is used. The average temperature T is an average of the two temperatures taking at the respective time intervals (e.g., T₃ and T₄ in the above example). The formula for determining the temperature T is as follows:

T=(T₃+T₄)/2. (6)

In step 24, the battery SOC is determined using SOC-OCV mapping. Mapping is derived through an OCV-to-SOC correlation table or similar mapping technique. The OCV-to-SOC values are derived from historical battery measurements and correlations, such that for an estimated OCV at a respective temperature a SOC value may be provided based on historical data.

While certain embodiments of the present invention have been described in detail, those familiar with the art to which this invention relates will recognize various alternative designs and embodiments for practicing the invention as defined by the following claims.

What is claimed is:

1. A method of determining a state-of-charge of a battery for a vehicle, the vehicle being in a charging state when the engine is operating and a non-charging state when the engine is not operating, the method comprising the steps of:
measuring a first battery voltage at a first predetermined time after battery charging is discontinued in the non-charging state;
measuring a first temperature of the battery coinciding with the first battery voltage;
measuring a second battery voltage at a second predetermined time after the first predetermined time with the vehicle in the non-charging state, the second predetermined time being greater than the first predetermined time;
measuring a second temperature of the battery coinciding with the second battery voltage;
calculating an average temperature based on the first temperature measurement and the second temperature measurement;
determining a fixed time constant based on the average temperature;
estimating an open circuit voltage as a function of the first voltage measurement, the second voltage measurement, and the fixed time constant; and
determining a state-of-charge of the battery based on the estimated open circuit voltage.

2. The method of claim 1 wherein the estimate open circuit voltage is determined based on the following formula:
$${OCV}_{( est )} = {V}_{3} - ( {V}_{3} - {V}_{4} ) \cdot \frac{{e}^{3 \times 3600 \times m} - {e}^{t \times 3600 \times m}}{{e}^{3 \times 3600 \times m} - {e}^{4 \times 3600 \times m}}$$
where V₃ is the first measured temperature, V₄ is the second measure temperature, m is the fixed time constant, and t is a selected time when the open circuit voltage is at equilibrium.

3. The method of claim 2 wherein the open circuit voltage is determined at a time when the open circuit voltage reaches equilibrium, wherein the selected time when the open circuit voltage reaches equilibrium is 24 hours after the vehicle is in the non-charging state.

4. The method of claim 2 wherein the open circuit voltage is determined at a time when the open circuit voltage reaches equilibrium, wherein the selected time when the open circuit voltage reaches equilibrium is at least 8 hours after the vehicle is in the non-charging state.

5. The method of claim 2 wherein the fixed time constant m is determined based on the following ranges:
$$if T \geq 25 C , then m = {m}_{25} = - 3 \times {10}^{- 5} , \\ if T \leq 0 C , then m = {m}_{0} = - 2 \times {10}^{- 5} , \\ if 0 C < T < 25 C , then m = {m}_{0} + \frac{T}{25} ( {m}_{25} - {m}_{0} ) .$$

6. The method of claim 1 wherein the first predetermined time is at least three hours after the vehicle enters the non-charging state.

7. The method of claim 6 wherein the second predetermined time period is greater than the first predetermined time period.

8. The method of claim 6 wherein the non-charging state begins when a vehicle ignition switch is turned to an off position.

9. The method of claim 1 wherein determining the state-of-charge from the open circuit voltage includes utilizing historical data to correlate the state-of-charge to the estimated open circuit voltage.

10. The method of claim 1 wherein the state of charge of the battery is displayed to a user of the vehicle via a display device.

11. The method of claim 1 wherein a representation of the state of charge of the battery is displayed to a user of the vehicle via a display device.

12. The method of claim 1 wherein the state of charge is provided to an electronic control unit for regulating voltage of the vehicle.

13. A system for determining a state-of-charge of a battery for a vehicle, the vehicle being in a charging state when the engine is operating and a non-charging state when the engine is not operating, the system comprising:
a battery;
a voltmeter for measuring a first battery voltage at a first predetermined time after battery charging is discontinued in the non-charging state, and for measuring a second battery voltage at a second predetermined time after battery charging is discontinued, the second predetermined time being greater than the first predetermined time;
a temperature sensor for measuring a first temperature of the battery coinciding with the first battery voltage, and for measuring a second temperature of the battery coinciding with the second battery voltage; and
a control module for determining a fixed time constant as a function of the first and second temperature measurements, the control module estimating an open circuit voltage at equilibrium as a function of the first battery voltage, the second battery voltage, and the fixed time constant, wherein the control module determines a state-of-charge of the battery based on the estimated open circuit voltage.

14. The system of claim 13 wherein the control module determines an average temperature as a function of the first temperature measurement and the second temperature measurement, and wherein the control module determines the fixed time constant as a function of the average temperature.

15. The system of claim 14 wherein the control module estimates the open circuit voltage based on the following formula:
$${OCV}_{( est )} = {V}_{3} - ( {V}_{3} - {V}_{4} ) \cdot \frac{{e}^{3 \times 3600 \times m} - {e}^{t \times 3600 \times m}}{{e}^{3 \times 3600 \times m} - {e}^{4 \times 3600 \times m}}$$
where V₃ is the first measured temperature, V₄ is the second measured temperature, m is the fixed time constant, and t is a selected time when the open circuit voltage is at equilibrium.

16. The system of claim 15 wherein the fixed time constant in is determined based on the following ranges:
$$if T \geq 25 C , then m = {m}_{25} = - 3 \times {10}^{- 5} , \\ if T \leq 0 C , then m = {m}_{0} = - 2 \times {10}^{- 5} , \\ if 0 C < T < 25 C , then m = {m}_{0} + \frac{T}{25} ( {m}_{25} - {m}_{0} ) .$$

17. The system of claim 15 wherein the selected time when the open circuit voltage is at equilibrium is 24 hours.

18. The system of claim 13 further comprising a display device for displaying the state of charge to a user of the vehicle.

19. The system of claim 13 further comprising a display device for displaying a representation of the state of charge to a user of the vehicle.

20. The system of claim 13 further comprising an electronic control unit for regulating the voltage of the vehicle, wherein the state of charge is provided to the electronic control unit for regulating the voltage of the vehicle based on the state-of-charge of the battery.
